(19) United States
(12) Patent Application Publication
(10) Pub. No.: US 2026/0309890 A1
(43) Pub. Date: Oct. 8, 2026

(54) LEVERAGING FIBER OPTIC-BASED PIPELINE MONITORING FOR MICROSEISMIC MONITORING

(71) Applicant: SCHLUMBERGER TECHNOLOGY CORPORATION, Sugar Land, TX (US)

(72) Inventors: Joel Herve Le Calvez, Richmond, TX (US); Adnan Chughtai, Southampton (GB); Colin Allan Wilson, Gatwick (GB); Nicholas FUNDYTUS, Edmonton (CA); Pierre BETTINELLI, Bucharest (RO)

(21) Appl. No.: 18/998,273

(22) PCT Filed: Jul. 25, 2023
(86) PCT No.: PCT/US2023/028592

§ 371 Date: Jan. 24, 2025

Related U.S. Application Data
(60) Provisional application No. 63/369,265, filed on Jul. 25, 2022.

(51) Int. Cl. G01V 8/16; G01D 5/353; G01M 3/38

(52) U.S. Cl. CPC G01V 8/16; G01D 5/35316; G01M 3/38

(57) ABSTRACT

Embodiments presented provide for a fiber-optic based pipeline monitoring system and method that senses, records and evaluates micro-seismic events near the monitored pipeline. The method includes locating at least one fiber optic line within an ecosystem of a pipeline, operating the pipeline to carry a fluid through the ecosystem, and monitoring the at least one fiber optic line during the carrying of the fluid through the pipeline. The monitoring the at least one fiber optic line includes obtaining at least one signal from both the pipeline and the ecosystem.

### CROSS-REFERENCE TO RELATED APPLICATIONS

This application claims priority to and the benefit of U.S. Provisional Application No. 63/369,265, entitled “Leveraging Fiber Optic-Based Pipeline Monitoring For Microseismic Monitoring,” filed Jul. 25, 2022, which is hereby incorporated by reference in its entirety for all purposes.

### FIELD OF THE DISCLOSURE

Aspects of the disclosure relate to monitoring of pipelines. More specifically, aspects of the disclosure relate to using fiber optic lines to monitor pipelines for leaks (e.g., oil, gas, liquified natural gas including CO2, etc.) and for identifying potential hazards in the proximity of the pipeline.

### BACKGROUND

Monitoring of pipelines and the surrounding environments is an important part of providing services related to transport of materials, such as hydrocarbons, CO2, etc. in modern life. With the transport of hydrocarbons and liquids (e.g., CO2, etc.), there is the ever-present possibility of the contents in the pipeline leaking to the outside environment or contents of the outside environment leaking into other parts of the outside environment. Such leaks may be minor and immediately contained. Other leaks, however, are more serious and may result in the release of larger quantities of hydrocarbons, CO2, etc. into the surrounding ecosystem or outside of those surrounding ecosystems.

To eliminate the potential for leaks, regular maintenance activities are performed on pipelines. These maintenance activities include checking connections for tightness, performing visual inspections, performing regular coating investigations and remediations.

As pipelines age, other defects in the pipeline may occur, including corrosion, mechanical damage from the environment and fatigue. To identify defects for these types of issues, more intrusive investigations must be performed. Investigation of these types of damages, can take substantial amounts of effort, resources, and money to ensure the viability of the pipeline.

Microseismic events may cause stress on caprock in subsurface porous reservoirs used for storage of hydrocarbons, CO2, etc. and detection of these events is necessary to maintain the efficiency of storage sites.

While investigative measures may identify defects early, some types of damage may provide a catastrophic failure. Activities such as drilling, dropping of heavy loads and road traffic may cause catastrophic failure. In this event, the contents of the pipeline spill to the surrounding ecosystem. Currently, there are no conventional system that constantly monitor pipeline activities, as well as activities in the surrounding environments, to prevent leakage. Conventional systems include a series of mechanical strain gauges that are welded to a pipeline and exposed to the elements. These types of mechanical strain gauges are subject to corrosion and can give false readings in several instances, such as during high temperature weather. The other portion of conventional systems that monitor a geological stratum include the drilling of an observation well. These observation wells are conventionally drilled to an elevational level where a stimulation project, for example, is to be accomplished. Such wells are then cased to ensure wellbore integrity and a measuring package dropped into the well to perform the desired measurements. Such drilling of observation wells can be extremely cost prohibitive as the deep the observation well is required, the more costly the overall project becomes.

There is a need to provide a system that uses a high technology solution for pipeline monitoring.

There is a further need to provide a high technology solution that is easy and cost-effective to install.

There is a further need to provide a pipeline monitoring solution that provides a degree of accuracy that is conventionally not achievable in standard systems.

There is a further need to provide apparatus and methods that are easier to operate than conventional apparatus and methods.

There is a further need to provide apparatus and methods that do not have drawbacks, such as lack of immediately monitoring a pipeline for developing fault scenarios.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method is disclosed. The method may comprise locating at least one fiber optic line within an ecosystem of a pipeline and operating the pipeline to carry a fluid through the ecosystem. The method may also comprise monitoring the at least one fiber optic line during the carrying of the fluid through the pipeline, wherein the monitoring the at least one fiber optic line includes obtaining at least one signal from both the pipeline and the ecosystem.

In another example embodiment, an apparatus is disclosed. The apparatus is configured to monitor both a pipeline and a function occurring within a hydrocarbon field. The apparatus may be configured with at least one fiber optic line and at least one sensor attached to the fiber optic line. The apparatus may also be configured with at least one multiplexer attached to the fiber optic line and at least one communication system configured to relay data from the at least one sensor and the fiber optic line to a remote location.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is an above-ground pipeline and attending fiber optic cable enabling microseismic monitoring in one aspect of the disclosure.

FIG. 2 is a below-ground pipeline and attending fiber optic cable enabling microseismic monitoring in another aspect of the disclosure.

FIG. 3 is a method for performing monitoring of a pipeline using a fiber optic cable using microseismic monitoring and evaluation in another aspect of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer, or section. Terms such as “first”, “second” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

Embodiments described herein provide a system that has two functions. The system may monitor a pipeline that transports a fluid. The fluid may be, for example, a hydrocarbon based material such as oil or gas. The system may also provide for monitoring of geological conditions in the ecosystem, thereby allowing operators the ability to check work that is ongoing and determine if activities are progressing as expected. Such monitoring of geological conditions may be, for example monitoring for stress, strain or vibrations that occur after a stimulation project is being completed. Such stimulation may occur in several different aspects, including hydraulic fracturing operations, steam assisted gravity drainage (SAGD) operations and water pumping/flooding operations. As will be understood, other types of activities may be accomplished, and the list described above should not be considered limiting.

In conventional systems, two different types of systems are used, mainly one attached to a pipeline system and one that monitors the geological conditions. The system that monitors the geological conditions may be very expensive to install. Such conventional systems include the drilling of an observations well to a required depth. As a results of these two systems, costs for overall drilling operations can be prohibitively high. As easy to reach hydrocarbon reserves are used, costs of recovery increase as the technology that is required to be used to recover the hydrocarbons becomes more intensive. These problems, however, are avoided with aspects of the disclosure provided here.

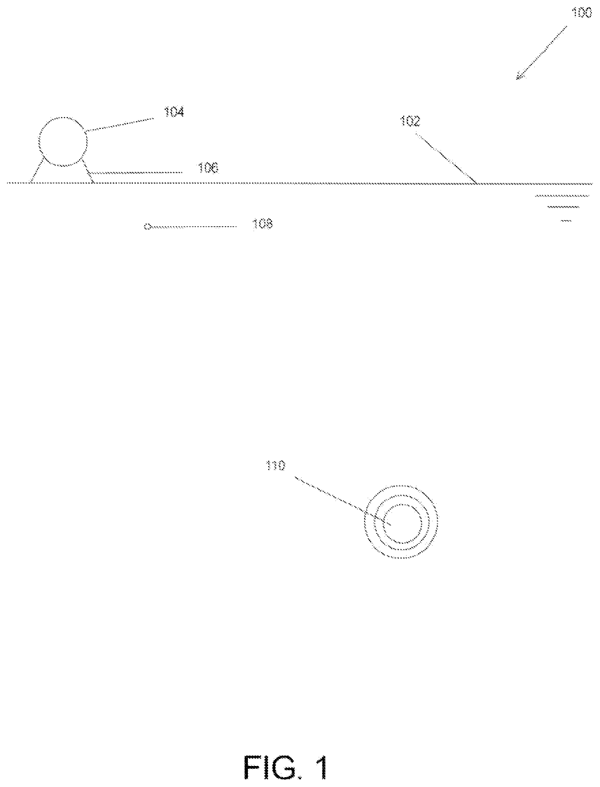

Referring to FIG. 1, a side elevational view of one embodiment of the disclosure is presented. A system 100 is illustrated wherein a pipeline 104 is supported by a stand 106 at the surface 102 of a geological stratum. A fiber optic line 108 is located in the proximity of the pipeline 104 such that properties may be measured. The properties measured may include temperature change, vibration, and stress. At the start of the placement of the fiber optic line 108, baseline readings of the fiber optic line 108 are recorded. At times thereafter, deviations from these base readings indicate changes in the ecosystem around the pipeline 104. These changes may occur from a leak, for example, either from the pipeline 104 or from the surrounding environment (e.g., a storage site for CO2).

In addition to the readings described above, other parameters may be measured. These include the overall state of the geological stratum in which the fiber optic line 108 is placed. As illustrated, an event occurring in the stratum may produce vibration throughout the geological stratum. These changes may be recorded by the fiber optic line 108 and transferred to an operator. In one example embodiment, time matching may be accomplished wherein the time of the event, such as a stimulation, is matched to the received signal. At that time, operators can verify if the stimulation was sensed by the fiber optic line 108 to the magnitude expected. As a result, the fiber optic line 108 can perform two functions at the same time, different than conventional fiber optic monitoring of pipelines which are limited to one action.

As will be understood, the fiber optic line 108 may be equipped with fiber optic strain sensors to allow for the reading of the strain in the fiber optic line 108. In one example embodiment, Bragg grating sensors may be installed at periodic intervals along the fiber optic line to measure individual points. In some embodiments, an interrogator may be included along the fiber optic line 108 as well as a multiplexer and a data recorder. As will be understood, different Bragg grating sensors may be used to allow operators the ability to pinpoint specific areas of concern, such as corners or bends in pipelines that may be more prone to defects. The use of Bragg grating sensors, in some applications, allows for a cost efficient and relatively fault tolerant system that may be extended for progressively long lengths. The Bragg grating systems include a distributed Bragg reflector that may be, for example, 4 to 6 millimeters long. The Bragg grating, in some embodiments, acts as a filter, reflecting particular wavelengths of light and transmitting others. In embodiments, the Bragg reflectors may be altered in size to reflect wavelengths desired within the fiber optic line 108. In some embodiments, a single type of Bragg grating will be used consistently throughout the entire system 100. In other embodiments, different types of Bragg gratings may be used to highlight different areas of the system 100. As the sensor is compressed and/or stretched, the output of the Bragg grating, called a Bragg wavelength, is changed. The equation that illustrated the Bragg wavelength is as follows:

$${λ}_{B} = 2 n \cdot ∧ \qquad EQ . 1$$

where n is the reflective index of the core of the fiber optic line and
Λ is the grating period.
   As can be seen from above, the grating period, or construction of the Bragg sensor, is a constant value.

Power may be supplied to the entire system 100 through an uninterruptable power supply. Such power supply may be provided with a battery back up and/or environmentally friendly alternatives, such as solar power capabilities. Non-limiting embodiments may use, for example, 230V AC systems. Other types of voltage supplies may be used according to the needs of the project.

The overall system 100 may be subdivided into various segments that may be connected to a central computer system that receives data. As will be understood, pipelines may extend for considerable lengths, therefore running large amounts of power, control and data cables may be cost prohibitive. To alleviate these concerns, periodic use of routers may be performed to allow data to be sent over wireless communication networks. These wireless communication networks may include any type of communication protocol, such as 2G, 3G, 5G or other systems to transfer the data. Other types of communication networks may be used, including broad band internet capable networks, telephone lines and satellite communication networks. As will be understood, all of the data may be sent to a central operations center that accumulates such data, such as an oil field services technical center, that processes the data and provides a synopsis of the data to a hydrocarbon field owner.

In embodiments, when discussed as a fiber optic line 108, multiple types of configurations may be possible. These types of configurations include, for example, a fiber optic cable which includes several individual fiber optic lines. Thus, although disclosed as a single line, more than one line may be used to provide redundancy of measurements or individual lines may be dedicated to individual sensing functions. As will be understood by people skilled in the art, the number of individual lines may be predicated upon the number of properties to be measured. As an example, if only one parameter is of critical importance to operations, then the number of individual fiber optic lines may be reduced. Alternatively, the number of individual fiber optic lines may be increased if multiple measurements must be made. In one or more embodiments, the measurements can be recorded, monitored, or combinations thereof. The measurements can be used by an operator, or a processor configured to receive the measurements, or combinations thereof to issue notifications and/or alarms if measurements are outside of a predetermined threshold. In one or more embodiments, the measurements can be combined with other observations, such as flow rate, pressure, or other pipeline parameters and displayed on a graphical user interface, such as a monitor or other device.

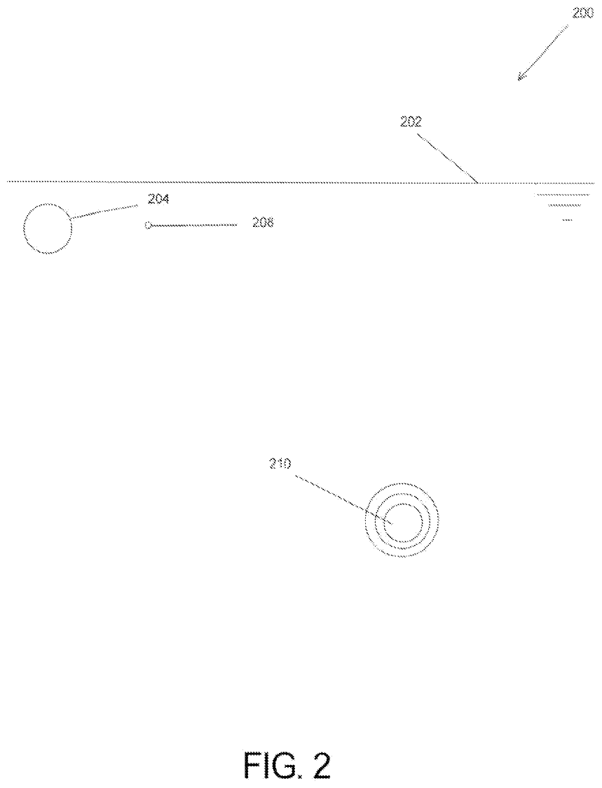

Referring to FIG. 2, a second embodiment of a system 200 is disclosed wherein the pipeline 204 is located within the geological stratum. Similar to the configuration in FIG. 1, a fiber optic line 208 is located in the vicinity of the pipeline 204. As seen from the ground level 202, the pipeline 204 and the fiber optic line 208 may be located at any depth.

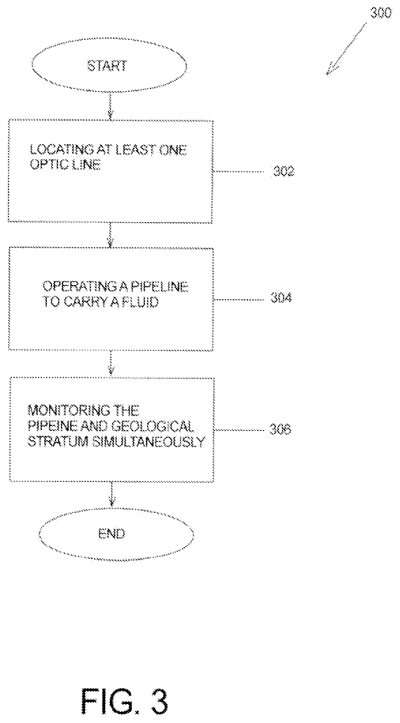

In one example embodiment and referring to FIG. 3, a method 300 is disclosed. The method 300 may comprise, at 302, locating at least one fiber optic line within an ecosystem of a pipeline. At 304, the method further comprises operating the pipeline to carry a fluid through the ecosystem or to deposit a fluid into the ecosystem. As will be understood and in conjunction with the other configurations described above, multiple fiber optic lines or a fiber optic cable may be used. In the illustrated embodiment, the fluid that is transferred through the pipeline is condensed hydrocarbons (heavy oil). In other configurations, the hydrocarbons transported may be natural gas or CO2. Such flow of hydrocarbons may occur from a transfer station as is typically found in oil field operations in hydrocarbon fields. Flow of hydrocarbons may also occur as the hydrocarbons enter or leave a storage facility at the surface, such as a tank farm.

At 306, the method may further comprise monitoring the at least one fiber optic line during the carrying of the fluid through the pipeline, wherein the monitoring the at least one fiber optic line includes obtaining at least one signal from both the pipeline and the ecosystem. In this step, the step of monitoring may include both the process of measuring a physical property from the ecosystem around the pipeline and within the geological stratum in which both the at least one fiber optic line and the pipeline are buried. Further, this step may include monitoring of a caprock integrity, where monitoring of the caprock integrity may include monitoring one or more of water table intrusion, CO2 plume evolution, or fracture propagation. Furthermore, in one or more embodiments, as a result of monitoring the at least one fiber optic line during the carrying of fluid through the pipeline, surface controls may be used to control the extraction rate or injection rate of the hydrocarbons, natural gas, or CO2 or to change an extraction point or injection point. In one or more embodiments, changing of the extraction point or injection point may include closing or opening one or more valves.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

In embodiments described herein, aspects provide a system that uses a high technology solution for pipeline monitoring.

In embodiments described herein, aspects provide a high technology solution that is easy and cost-effective to install.

In embodiments described herein, aspect provide a pipeline monitoring solution that provides a degree of accuracy that is conventionally not achievable in standard systems.

In embodiments described herein, aspects provide apparatus and methods that are easier to operate than conventional apparatus and methods.

In embodiments described herein, aspects provide apparatus and methods that do not have drawbacks, such as lack of immediately monitoring a pipeline for developing fault scenarios.

In one example embodiment, a method is disclosed. The method may comprise locating at least one fiber optic line within an ecosystem of a pipeline and operating the pipeline to carry a fluid through the ecosystem. The method may also comprise monitoring the at least one fiber optic line during the carrying of the fluid through the pipeline, wherein the monitoring the at least one fiber optic line includes obtaining at least one signal from both the pipeline and the ecosystem.

In one example embodiment, the method may be performed wherein the monitoring of the at least one fiber optic line by obtaining at least one signal from the ecosystem includes hydraulic fracture monitoring.

In one example embodiment, the method may be performed wherein the at least one signal from the ecosystem includes monitoring for an induced seismic activity within the ecosystem.

In one example embodiment, the method may be performed wherein the at least one signal is related to a stimulation activity.

In one example embodiment, the method may be performed wherein the at least one signal is related to an injection activity.

In one example embodiment, the method may be performed wherein the at least one signal is related to a production of hydrocarbons activity.

In one example embodiment, the method may be performed wherein the at least one signal is related to a process for monitoring of a caprock integrity.

In one example embodiment, monitoring of the caprock integrity may include monitoring one or more of water table intrusion, CO2 plume evolution, or fracture propagation.

In one example embodiment, the method may be performed wherein the monitoring is monitoring microseismic signals.

In one example embodiment, the method may further comprise evaluating the monitored microseismic signals.

In one example embodiment, the method may be performed wherein the locating the at least one fiber optic line within an ecosystem of the pipeline is in the ground.

In one example embodiment, the method may be performed wherein the pipeline is supported at ground level.

In one example embodiment, the method may be performed wherein the pipeline is supported underneath a surface of the ground.

In one example embodiment, the fluid carried through the pipeline is CO2.

In another example embodiment, an apparatus is disclosed. The apparatus is configured to monitor both a pipeline and a function occurring within a hydrocarbon field. The apparatus may be configured with at least one fiber optic line and at least one sensor attached to the fiber optic line. The apparatus may also be configured with at least one multiplexer attached to the fiber optic line and at least one communication system configured to relay data from the at least one sensor and the fiber optic line to a remote location.

In another example embodiment, the apparatus may be configured wherein the at least one sensor attached to the fiber optic line is a Bragg sensor.

In another example embodiment, the apparatus may be configured wherein the Bragg sensor is constructed with a Bragg reflector.

In another example embodiment, the apparatus may be configured wherein the Bragg reflector is configured with a constant period grating.

In another example embodiment, the apparatus may be configured wherein the at least one communication system configured to relay data from the at least one sensor and the fiber optic line to the remote location is a wireless network.

In another example embodiment, the apparatus may further comprise at least one data recording system attached to the at least one fiber optic line, the at least one data recording system configured to receive signals from the at least one sensor.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method, comprising:
locating at least one fiber optic line within an ecosystem of a pipeline;
operating the pipeline to carry a fluid through the ecosystem; and
monitoring the at least one fiber optic line during the carrying of the fluid through the pipeline, wherein the monitoring the at least one fiber optic line includes obtaining at least one signal from both the pipeline and the ecosystem.

2. The method according to claim 1, wherein the monitoring of the at least one fiber optic line by obtaining at least one signal from the ecosystem includes hydraulic fracture monitoring.

3. The method according to claim 1, wherein the at least one signal from the ecosystem includes monitoring for an induced seismic activity within the ecosystem.

4. The method according to claim 3, wherein the at least one signal is related to a stimulation activity.

5. The method according to claim 3, wherein the at least one signal is related to an injection activity.

6. The method according to claim 3, wherein the at least one signal is related to a production of hydrocarbons activity.

7. The method according to claim 3, wherein the at least one signal is related to a process for monitoring of a caprock integrity.

8. The method according to claim 7, wherein a process for monitoring of the caprock integrity comprises monitoring one or more of water table intrusion, CO2 plume evolution, or fracture propagation.

9. The method according to claim 1, wherein the monitoring is monitoring microseismic signals.

10. The method according to claim 9, further comprising:
evaluating the monitored microseismic signals.

11. The method according to claim 9, wherein the locating the at least one fiber optic line within an ecosystem of the pipeline is in the ground.

12. The method according to claim 9, wherein the pipeline is supported at ground level.

13. The method according to claim 9, wherein the pipeline is supported underneath a surface of the ground.

14. The method according to claim 1, wherein the fluid is CO2.

15. An apparatus configured to monitor both a pipeline and a function occurring within a hydrocarbon field, comprising:
at least one fiber optic line;
at least one sensor attached to the fiber optic line;
at least one multiplexer attached to the fiber optic line; and
at least one communication system configured to relay data from the at leas one sensor and the fiber optic line to a remote location.

16. The apparatus according to claim 15, wherein the at least one sensor attached to the fiber optic line is a Bragg sensor.

17. The apparatus according to claim 16, wherein the Bragg sensor is constructed with a Bragg reflector.

18. The apparatus according to claim 17, wherein the Bragg reflector is configured with a constant period grating.

19. The apparatus according to claim 15, wherein the at least one communication system configured to relay data from the at least one sensor and the fiber optic line to the remote location is a wireless network.

20. The apparatus according to claim 16, further comprising:
at least one data recording system attached to the at least one fiber optic line, the at least one data recording system configured to receive signals from the at least one sensor.
